(19) United States
(12) Patent Application Publication
(10) Pub. No.: US 2010/0102189 A1
(43) Pub. Date: Apr. 29, 2010

(54) Surface Pad

(76) Inventor: Matthew S. Pavone, North Brunswick, NJ (US)

Correspondence Address: WHITE-WELKER & WELKER, LLC, P.O. BOX 199, CLEAR SPRING, MD, 21722-0199, US

(21) Appl. No.: 12/573,184

(22) Filed: Oct. 5, 2009

Related U.S. Application Data
(60) Provisional application No. 61/107,922, filed on Oct. 23, 2008.

(51) Int. Cl. F16M 13/00; A47B 91/00

(52) U.S. Cl. 248/346.03; 248/346.01

(57) ABSTRACT

Surface pad comprises a thin pad that resembles a footprint of a laptop. Four equally sized and rounded feet that are visible when the laptop is placed on the surface pad for use. These feet are the primary touch points for the laptop user when he/she is repositioning the laptop. By placing a person's thumb and index finder on the circular ‘feet’ of the surface pad that adjust the laptop for viewing comfort on the work surface by sliding, turning or repositioning the laptop in a jostle-free manner. A circle cut from the center similar to a donut. A plurality of ventilation tracks or airflow tracks that run outwards from the circular hole all the way to edge of the surface pad. The underbelly of the surface pad is equipped with ingrained treading to insure friction on the work surface and added strength to the lifetime of the surface pad.

### CROSS REFERENCE TO RELATED APPLICATIONS

This application claims priority from U.S. Provisional Patent Application Ser. No. 61/107,922, entitled “Surface Pad”, filed on 23 Oct. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a surface pad. More specifically, the present invention relates to a laptop surface pad with additional novel features.

### BACKGROUND OF THE INVENTION

Presently, the market has a range of laptop accessories, including laptop docking stations that fix a laptop to a work surface, laptop elevating docking stations, electric and non-electric cooling pads, laptop elevating devices and foldable laptop stands. All of these have one, if not all, of the following traits: 1) fix the laptop to a work station or work surface; 2) are large in comparison to the laptop; 3) are bulky; 4) heavy in comparison to a laptop; 5) contain breakable internal parts; 6) contain breakable mechanisms such as fans and motors; 7) have breakable hinges; 8) cannot easily fit into most laptop bags along with the laptop 9) roughly 1″ thick or higher; 10) cannot be washed or rinsed with water or placed inside a dishwasher for through washing while still functioning afterwards; 11) are not one-size fits all; 12) require electric current or batteries.

In addition, many of the products known in the prior art do not account for USB ports that may be located on the laptop side surfaces, especially the left, right and rear of the laptop. Many prior art devices are not able to make this accommodation. Some of the prior art incorporate a folding mouse platform which further limits the free use of USB ports when the mouse pad is utilized for a mouse, hindering the use of the USB ports located on the side of the laptop the mouse and the mouse pad occupy. Other prior art fix the laptop to a docking station thereby making it difficult to fully access the USB ports located on the sides and rear of the laptop. The present invention accounts for the use of USB ports on all sides of the laptop to better suit the needs of the user as well as the varying needs of laptops manufactured by different companies.

None of the known products in the prior art are designed to protect the laptop from risks associated with the use of a laptop around liquid, near dust and food crumbs or other debris on the work surface. The present invention offers some protection during laptop usage in modern settings such as in a café or on a dining table in a moving train. None of the prior art is designed to withstand high temperatures that occur during the washing or cleaning of the product. Most of the prior art is not designed for washing or cleaning. Therefore, what is needed is a product that can withstand contact with liquids and table debris, protect the laptop's underside from direct contact with these agents and can then be washed clean for continued use.

What is also needed is a surface pad that does not require the use of rubber pads of any kind on any component of the surface pad. Prior art uses special rubber treads to enhance table friction. Or, prior art is manufactured from foam, rubber and/or plastic and that are designed to affix the laptop to the working station and prevent the free movement, sliding or adjustment of the laptop on the desired work service. This invention offers the ability to move the laptop with ease and adjust the position of the laptop to suit the ergonomic and viewing needs of the laptop users. This invention provides the mobility of a laptop in a more convenient way that enhances the shared use of the laptop at a workstation.

Additionally there is a need for a surface pad that can cool the laptop while performing additional functions. This invention provides for a buffer of space between the underside of the laptop and the top of the surface pad with the incorporation of airflow tracks. It also has a circular hole to further provide breathability and minimize the area of the surface pad that can absorb heat. What is needed is a cooling system that does not require the use of batteries or electric current. The current invention has no electric need or requirement, power cords or batteries.

Finally, what is needed is a surface pad that is lighter, more compact, and more easily portable compared to those known in the prior art. As noted, prior art may be heavy and reach over one pound and may be much thicker than ⅜ths of an inch. The current invention is specifically designed to be lightweight, strong, semi-flexible and slender to better suit the travel needs of the laptop user.

### SUMMARY OF THE INVENTION

A surface pad comprises a thin pad that resembles a footprint of a laptop. Four equally shaped and located feet that are visible when the laptop is placed on the surface during use. These four feet are the primary touch points for the laptop's rubber feet that are located on the underside of the laptop in each of the four corners. The laptop rests directly on the top of the surface pad and the four rubber feet of the laptop grip the four rounded feet of the surface pad. This allows a person to move the laptop by placing a thumb and index finder on the circular feet of the surface pad and applying pressure to move, slide, turn or adjust the laptop to better suit his/her ergonomic and viewing needs. He/she may also easily adjust the laptop for the viewing comfort of others while the laptop rests on the surface pad by sliding, turning or repositioning the laptop in a jostle-free manner.

A circle cut from the center similar to a donut. A plurality of ventilation tracks or airflow tracks that run outwards from the circular hole all the way to edge of the surface pad. These air flow tracks provide improved breathability and allow for improved ventilation and heat dispersion; much prior art is deficient in this. The underbelly of the surface pad is equipped with ingrained treading to ensure some friction on the work surface. The underbelly's engrained treading is also designed to strengthen the surface pad and prevent the warping of the surface pad and to ensure the surface pad is flat. The circular hole cut from the center also doubles as a handle for easy carrying of the surface pad.

The present invention teaches a surface pad with the ability to provide suitable and easy laptop mobility on any work surface in the home, office and elsewhere (e.g. cafes, restaurants, trains, bar surfaces, etc). This characteristic is as unique as is the slender, light and ‘fit-any-case’ design of the surface pad.

The present invention also teaches protection for the laptops underbellies that are at increased risk due to exposures to liquid, dust, crumbs and other debris that may be found on the work surface. The present invention offers some protection against these exposures.

Finally, the present invention offers an improved clearance height for the USB port. The distance between the USB port on the laptop and the work surface is maximized to account for oversized flash-drives that hit the work surface and lose information. The present invention elevates the laptop and thus offers the USB ports on any side of the laptop the an improved clearance from the work surface. When the USB device is plugged into the USB port this clearance allows the USB device to cleanly fit into the USB port without touching the table.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a top plane view of the surface pad of the present invention;

FIG. 2 is a bottom plane view of the surface pad of the present invention;

FIG. 3 is a side plane view of the surface pad of the present invention;

FIG. 4 is a cross sectional view of the surface pad of the present invention; and

FIG. 5 is a perspective axiom view of the surface pad of the present invention's bottom plane.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

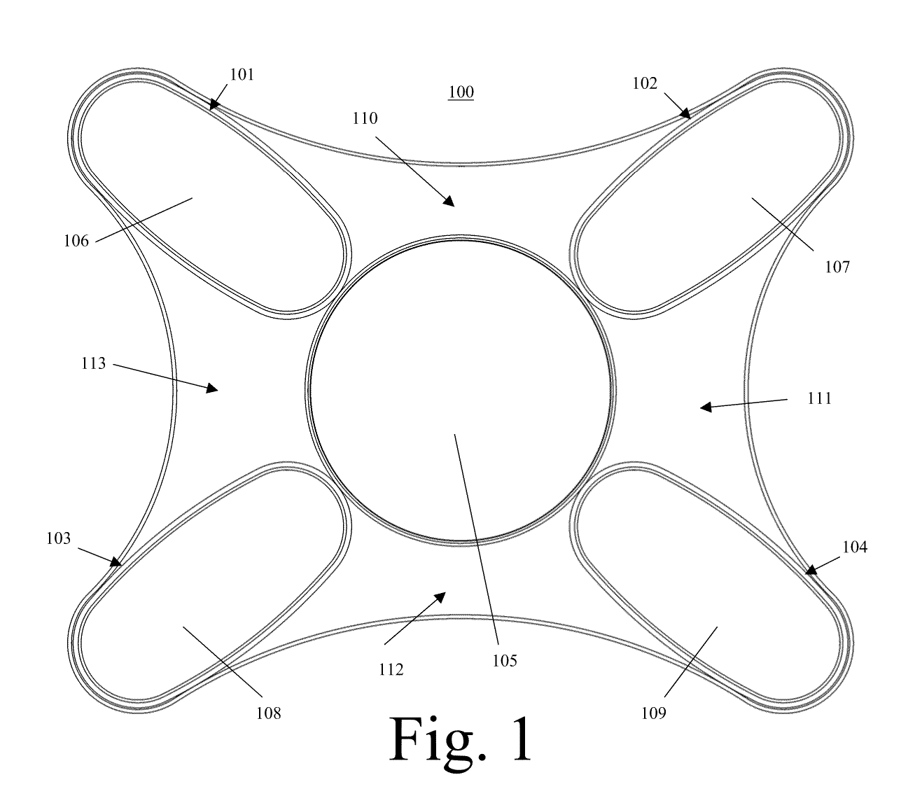

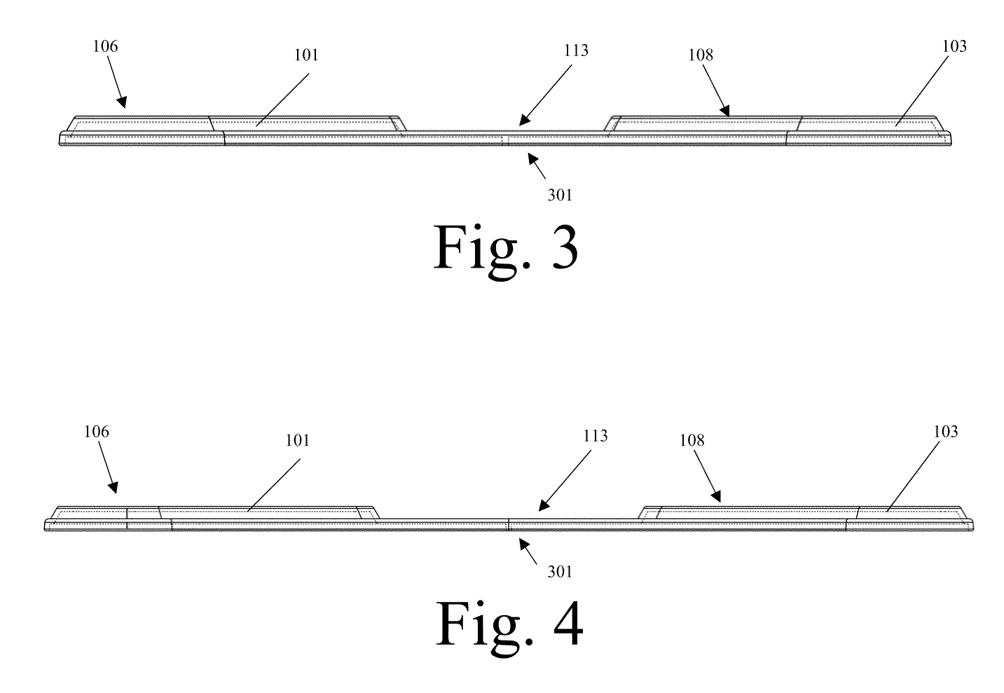

Now referring to the Figures, the embodiment of the laptop surface pad is illustrated. The surface pad 100 is a thin pad that resembles a foot-print of a laptop as shown in FIG. 1. The surface pad 100 consists of a semi-circular rounded end portions 106, 107, 108, and 109 also referred to as feet; a middle portion 301, each of said portions having a top surface 110, a bottom surface 216 and a side surface 209 extending around the perimeter of the top surface 110 and bottom surface 216 having a thickness. Instead of squared corners however, the surface pad 100 has four equally sized rounded feet 106, 107, 108, and 109 that are visible as shown in FIGS. 3 and 4, when the laptop is placed on the surface pad 100 for use. These feet 106, 107, 108, and 109 are the primary touch points on the surface pad 100 for the user when he/she is repositioning the laptop. By placing a thumb and index finder on any two of the four the circular feet parts 106, 107, 108, and 109 of the surface pad 100 the laptop user may easily adjust the laptop for viewing comfort on the work surface by sliding, turning, pushing and repositioning the laptop in a jostle-free manner.

The surface pad 100 has a circle cut from the center 105 similar to a donut. This simultaneously allows for a lighter product, a cleaner design look and also offers a degree of laptop breathability and heat ventilation. There is also a plurality of ventilation tracks or airflow tracks 110, 111, 112, and 113 that run outward in a direction from the circular hole 105 to the curved edges 209 of the surface pad 100 where they exit to the atmosphere. The perimeter curved edge 209 of the surface pad 100 may be rounded or have a taper to reduce the potential for snagging or cutting other objects.

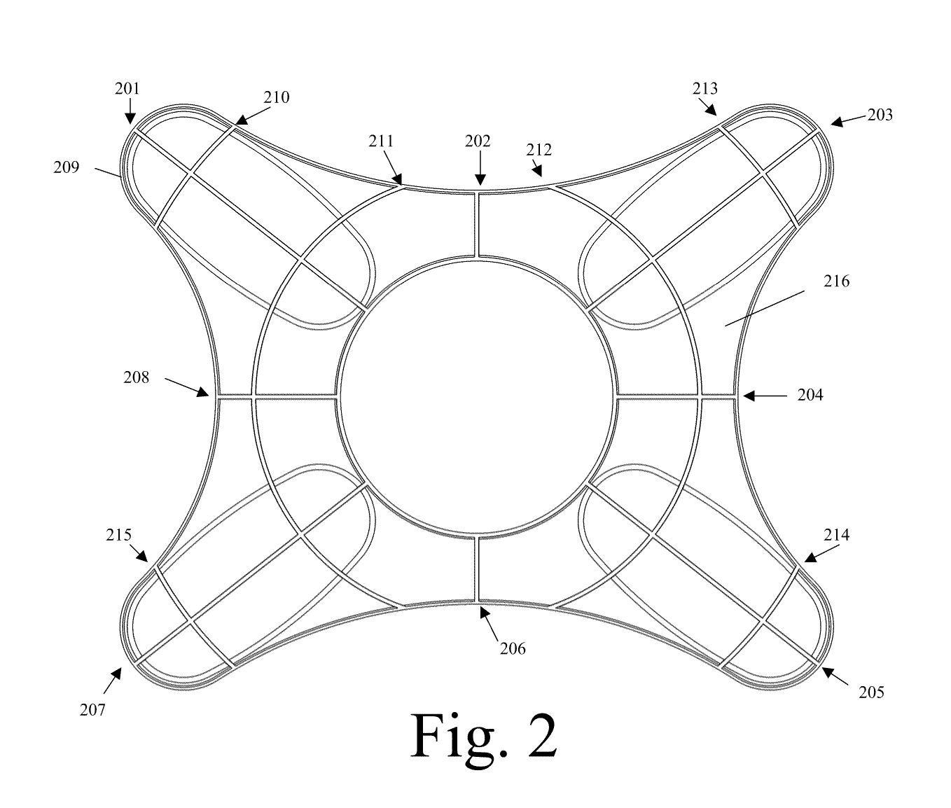

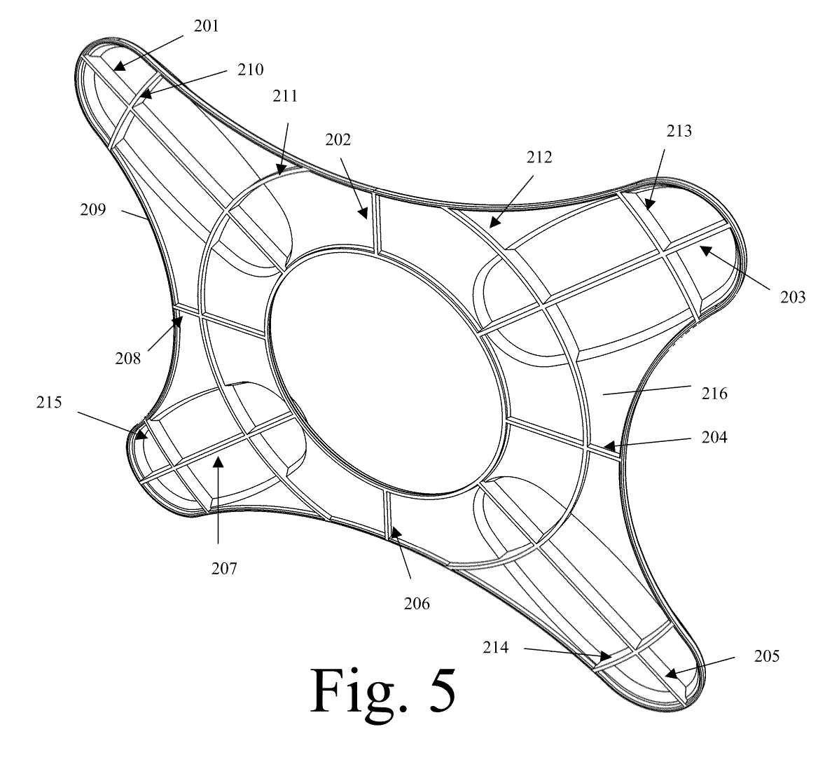

Additionally, a plurality of thin struts 210, 211, 212, 213, 214, and 215 run circular in a parallel location to the circular hole 105 on the bottom of the surface pad and are intersected by a plurality of perpendicular struts 201, 202, 203, 204, 205, 206, 207, and 208 that run radially outward from the circular hole 105 to edge of the surface pad. A webbed and interconnected combination of these struts is thus created. This webbed bottom serves as the point of contact between the surface of a table and surface pad 100, which then helps insure some friction between the surface pad 100 and a table. This web is shown in FIGS. 2 and 5. The circular hole 105 also doubles as a handle for easy carrying of the surface pad.

Once placed between the laptop and any work surface, a laptop grips the surface pad 100 at points where a laptop's rubber feet contact the top surfaces 106, 107, 108, and 109 of the surface pad's 100 feet 106, 107, 108, and 109. This allows the laptop to adhere to the surface pad 100 under its own natural weight and allows the surface pad 100 to be utilized to achieve four key activities. First, it provides the needed dimension of mobility to the laptop user. Spinning, turning, adjusting and readjusting are all effortless actions that will no longer wear on the life the laptop that occurs when these movements are performed without the aid of the surface pad. In a jostle free manner, the laptop can be repositioned for ergonomic comfort and better viewing for the user. Second, the surface pad raises the laptop off the work surface to provide a greater space between an inserted USB drive and the table's surface, a benefit that allows users with oversized or large USB drives to cleanly insert the drive into the USB port without the USB drive touching the table or leaning against the table; a position that increases the risk of lost information.

Additionally, the small increase in USB surface-to-port clearance does help reduce the bumps and knocks sustained by the USB drive caused by workspace clutter. Third, the surface pad offers a basic degree of protection against liquids, crumbs, dust, and other unknown agents on familiar and unfamiliar work surfaces. By separating the laptop from the table or work surface, the laptop is protected from unknown or clear liquids and debris that may be on the work surface. Finally, the surface pad provides a form breathability for the underside of the laptop vis-à-vis the air flow tracks 110, 111, 112, and 113 and a centrally located hole 105 that both help disperse the heat away from the laptop's underside.

Also noteworthy are the dimensions of the surface pad that have been carefully measured to accommodate over 95% of the laptops sold on the market.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A surface pad comprising:
a pad consisting of a semi-circular rounded end portions and a middle portion, each of said portions having a top surface, a bottom surface and a side surface extending around the perimeter of the top and bottom surfaces having a thickness;
four equally sized and rounded feet located on the top side of each semi-circular rounded end portion;
an opening cut from the center of the middle portion of the surface pad; and
a plurality of ventilation tracks on the top side of the surface pad which run outward from the center opening to edge of the surface pad.

2. The surface pad of claim 1 wherein the opening cut from the center of the pad is in the shape of a circle.

3. The surface pad of claim 1 further comprising handhold cutouts extending through the top and bottom surfaces.

4. The surface pad of claim 1 wherein the pad has a rounded or increased taper on each side surface around its perimeter.

5. The surface pad of claim 1 wherein the pad is essentially a four pointed star shape caused by the semi-circular rounded end portions and a reduction in width at the middle portion.

6. The surface pad of claim 1 wherein said feet provide the primary touch points for a laptop.

7. The surface pad of claim 1 further comprising ingrained treading on the bottom side of the pad.

8. The surface pad of claim 7 wherein the ingrained treading on the bottom side of the pad is located on the bottom surface of the struts.

9. The surface pad of claim 1 wherein the plurality of ventilation tracks run radially outward across the top surface of the surface pad in a perpendicular direction from the opening cut from the center of the middle portion of the pad to the edge of the surface pad.

10. The surface pad of claim 9 further comprising a first plurality of struts that run circular in a parallel location to the opening cut from the center of the middle portion and intersect a second plurality of struts that run radially outward in a perpendicular direction from the opening cut from the center of the middle portion of the pad to edge of the surface pad.
